(19) United States
(12) Patent Application Publication
(10) Pub. No.: US 2005/0215153 A1
(43) Pub. Date: Sep. 29, 2005

(54) Dextrin binder composition for heat resistant non-wovens

(76) Inventors: Marc R. Cossement, Chaineux (BE); Jean-Marc P. Henrion, Theux (BE)

Correspondence Address: OWENS CORNING, 2790 COLUMBUS ROAD, GRANVILLE, OH, 43023, US

(21) Appl. No.: 10/807,224

(22) Filed: Mar. 23, 2004

(51) Int. Cl. B32B 17/04; B32B 17/02

(52) U.S. Cl. 442/180

(57) ABSTRACT

A polycarboxy binder composition that contains a dextrin as a co-binder is provided. The dextrin co-binder may be a dextrin, a modified dextrin, a maltodextrin, or combinations thereof. The dextrin may be chemically modified. A pre-binder composition is formed that contains a polycarboxy polymer, a crosslinking agent, and optionally a catalyst. The polycarboxy polymer may be a homopolymer or copolymer prepared from unsaturated carboxylic acids and may be modified to contain one or more vinyl compounds. The crosslinking agent may be a polyol that contains at least two hydroxyl groups. The pre-binder composition may be formed by admixing the polycarboxy polymer, the crosslinking agent, and optionally, the catalyst, in a mixing device. Dextrin may be added to the pre-binder composition in an amount of from 10-75% of the total binder composition. The dextrin binder composition may have a ratio of from approximately 90:10 to 25:75 pre-binder:dextrin co-binder.

### TECHNICAL FIELD AND INDUSTRIAL APPLICABILITY OF THE INVENTION

The present invention relates generally to binder compositions for glass fibers, and more particularly to a polycarboxylic acid binder composition that contains dextrin, modified dextrin, or maltodextrin as a co-binder.

### BACKGROUND OF THE INVENTION

Glass fiber mats are commonly used in a variety of applications, such as in reinforced thermoset and thermoplastic composites, in textiles, in acoustical and thermal insulation products, and as reinforcing elements for roofing shingles, siding, and composite flooring. In addition to primary dry tensile and wet tensile properties at either room temperature or at an elevated temperature, a high degree of flexibility and tear strength is desired in fibrous glass mats.

Fibrous glass mats may be formed in a variety of manners. For example, fibrous glass insulation mats are generally formed by drawing molten streams of glass through a bushing or orifice to form fibers of random lengths. These fibers are then blown into a forming chamber where they are randomly deposited as a mat onto a conveyor belt. The fibers are typically sprayed with a curable liquid binder as they are deposited onto the conveyor belt. The coated fibrous mat may then be transferred to a curing oven to cure the binder and rigidly bond the glass fibers together.

Glass fiber mats, such as those used as reinforcing elements for flooring or roofing shingles, may be formed by conventional dry-laid or wet-laid processing. In a dry-laid process, glass fibers are chopped and air blown onto a conveyor. A binder is then applied to the fibers to form a mat. Dry-laid processes are particularly suitable for the production of highly porous mats where an open structure is desired to allow the rapid penetration of various liquids or resins.

In a conventional wet-laid process, chopped glass fibers are added to a water slurry which may contain surfactants, viscosity modifiers, defoaming agents, or other chemical agents. Once the chopped glass fibers have been introduced into the slurry, the slurry is agitated so that the fibers are dispersed throughout the slurry. The slurry containing the fibers is then deposited onto a moving screen, and a substantial portion of the water is removed. Next, a binder is applied, and the resulting mat is dried to remove the remaining water and cure the binder. The formed non-woven mat is an assembly of dispersed, individual glass filaments. Wet-laid process are commonly used when a very uniform distribution of fibers is desired.

Phenol-formaldehyde binders have been widely used in the past in the formation of glass fiber mats because they have a low viscosity in an uncured state yet form a rigid thermoset polymeric matrix for the glass fibers when cured. However, phenol-formaldehyde binders release a significant amount of formaldehyde into the environment while the binder is being cured. In addition, formaldehyde may be released from the cured binder, especially when the cured binder is exposed to acidic environments. Formaldehyde is toxic by inhalation, a strong irritant, and a carcinogen. Therefore, formaldehyde release is undesirable, particularly in enclosed spaces, because the formaldehyde may be inhaled by workers. Another disadvantage of phenol-formaldehyde binders is that these binders have a limited shelf life due to binder instability. This short shelf life leads to increased manufacturing costs in terms of frequent cleanup and increased binder production. Thus, a binder that did not emit formaldehyde was desired.

In this regard, polycarboxylic acid based fiberglass binder compositions have become widely used as a binder in the formation of fiberglass mats.

U.S. Pat. No. 5,318,990 to Strauss discloses a polycarboxylic acid based binder that includes a polycarboxy polymer (e.g., polyacrylic acid), a monomeric trihydric alcohol (e.g., glycerol or trimethylolpropane), and a catalyst (e.g., a phosphorous accelerator). Other polyols may optionally be present. The composition relies on the presence of the phosphorus accelerator to obtain an effective cure at suitable temperatures.

U.S. Pat. No. 5,346,688 to Strauss et al. discloses a binder for making a fiberglass mat that includes a combination of a polycarboxy polymer (e.g., polyacrylic acid), a β-hydroxyalkylamide, and at least one tri-functional monomeric carboxylic acid such as citric acid, trimellitic acid, hemimellitic acid, trimesic acid, tricarballylic acid, 1,2,3,4-butanetetracarboxylic acid (BTCA), or pyromellitic acid.

U.S. Pat. No. 5,661,213 to Arkens et al. describes a formaldehyde free aqueous binder that includes a polyacid (e.g., polyacrylic acid) and a polyol that is at least a diol with a molecular weight less than about 1,000 (e.g., ethylene glycol, glycerol, pentaerythritol, trimethylol propane, sorbitol, sucrose, glucose, resorcinol, catechol, pyrogallol, glycollated ureas, 1,4-cyclohexane diol, diethanolamine, triethanolamine, and certain reactive polyols such as β-hydroxyalkylamides). The binder composition relies on the presence of a phosphorus accelerator in the aqueous solution to obtain an effective cure at suitable temperatures.

U.S. Pat. No. 5,932,689 to Arkens et al. discloses an aqueous binder that includes a combination of a polyacid (e.g., polyacrylic acid), an active hydrogen-containing compound (e.g., a polyol or a polyamine), and a cyanamide, a dicyanamide or a cyanoguanidine. In this binder formulation, the presence of a catalyst is optional. Suitable catalysts include a phosphorus or fluoroborate compound.

U.S. Pat. No. 5,977,232 to Arkens et al. describes a formaldehyde free binder composition that includes a polyacid (e.g., polyacrylic acid), an active hydrogen-containing compound containing at least two active hydrogen groups (e.g., hydroxyl, primary amino, secondary amino, or mixtures thereof), a fluoroborate accelerator, and a phosphorous containing accelerator.

U.S. Pat. No. 6,071,994 to Hummerich et al. discloses an aqueous binder that includes a polymer containing (A) an ethylenically unsaturated acid anhydride (e.g., dicarboxylic anhydrides) or an ethylenically unsaturated dicarboxylic acid whose carboxyl groups can form an anhydride group and (B) an alkanolamine having at least two hydroxyl groups. A phosphorus containing accelerator is optionally included. The polymer includes copolymers containing, as one monomer, (A) as described above, and a second monomer such as acrylic acid, methacrylic acid, ethylacrylic acid, allylacetic acid, crotonic acid, vinylacetic acid, or a maleic monoester.

U.S. Pat. Nos. 6,099,773, and 6,146,746 to Reck et al. describe binder compositions that include (A) a polymer containing from 5 to 100% by weight of units derived from an ethylenically unsaturated acid anhydride or an ethylenically unsaturated dicarboxylic acid whose carboxyl groups are capable of forming an anhydride group and (B) an alkanolamine having at least two hydroxyl groups. The polymer may be a copolymer containing (A) as described above and a monomer such as acrylic acid, methacrylic acid, ethylacrylic acid, allylacetic acid, crotonic acid, vinylacetic acid, or a maleic monoester.

U.S. Pat. No. 6,299,936 to Reck et al. describes a thermally curable aqueous composition that includes (A) at least one polymer obtained by free-radical polymerization that contains ≦5% by weight of an α, β-ethylenically unsaturated mono- or dicarboxylic acid in copolymerized form, (B) at least one polymer obtained by free-radical polymerization that includes ≧15% by weight of an α, β-ethylenically unsaturated mono- or dicarboxylic acid in copolymerized form, and (C) at least one alkanolamine having at least two hydroxyalkyl groups.

U.S. Pat. No. 6,331,350 to Taylor et al. describes a binder formulation for fiberglass that has a pH of no less than 3.5 which includes a polycarboxy polymer (e.g., polyacrylic acid) and a polyol having at least two hydroxyl groups (e.g., glycerol). It is preferred that the polycarboxy polymer has a molecular weight of less than 10,000. The binder also preferably includes a catalyst which is an alkali metal salt of a phosphorus polyol and a catalyst which is an alkali metal salt of a phosphorus-containing organic acid.

U.S. Patent Publication No. 2002/0091185 to Taylor et al. describes a fiberglass binder composition that includes a polycarboxy polymer (e.g., polyacrylic acid) and a polyol (e.g., glycerol). The amount of polycarboxy polymer and polyol contained in the binder is such that the ratio of equivalents of hydroxyl groups to carboxy groups is preferably in the range of from about 0.6/1 to 0.8/1.

U.S. Patent Publication No. 2002/0188055 to Chen et al. discloses a fiberglass binder composition made from a polycarboxy polymer (e.g., polyacrylic acid), a polyhydroxy crosslinking agent (e.g., a triethanolamine or glycerol), and a cationic surfactant, amphoteric surfactant, nonionic surfactant, or mixture thereof.

U.S. Patent Publication No. 2003/0008978 to Chen et al. discloses a polyacrylic acid based binder composition in which the acidic binder composition is formed by polymerizing an acrylic acid monomer in water in the presence of a cure accelerator (i.e., an alkali metal salt of a phosphorous-containing inorganic acid) to form a low molecular weight polyacrylic acid. This low molecular weight polyacrylic acid is then reacted with a polyhydroxy crosslinking agent in a crosslinking step. No catalyst is needed to react the acid with the monomeric trihydric alcohol.

In U.S. Patent Publication No. 2004/0002567 to Chen et al., a polycarboxylic acid based binder composition is disclosed which includes a polycarboxylic acid (e.g., polyacrylic acid) crosslinked with either glycerol or triethanolamine. A silane-coupling agent is typically added to the binder composition in an amount of about 0.1% based on binder solids. The binder composition has a loss of ignition value of between approximately 15 and 20% and is applied in a one-step process.

U.S. Patent Publication No. 2004/0033747 to Miller et al. describes an aqueous binder composition that includes (A) an aqueous hydroxy functional, carboxy functional addition polymer and (B) a condensation accelerator. The hydroxyl functional, carboxy functional polymer includes the reaction product of at least 5% by weight of an α, β-ethylenically unsaturated hydroxy monomer, at least 30% by weight of an ethylenically unsaturated carboxylic acid monomer, from 0% to less than 50% by weight of an α, β-ethylenically unsaturated non-hydroxy functional, non-carboxy functional monomer, and a chain transfer agent. The binder composition may be provided as a one part formulation.

Although polycarboxylic acid based binder compositions such as are described above have eliminated many of the problems associated with conventional formaldehyde binders, polycarboxylic acid based binder compositions have higher cure temperatures and longer cure times than formaldehyde binder compositions. As a result, more energy expended and more time is needed to cure a polycarboxylic acid based binder composition, which results in increased manufacturing time and increased costs. Thus, there exists a need in the art for alternative binder compositions that achieve desired physical properties and which reduce the costs associated with existing polycarboxylic acid based binders.

### SUMMARY OF THE INVENTION

It is an object of the invention to provide a dextrin binder composition. The binder composition includes a pre-binder composition that contains a polycarboxy polymer, a crosslinking agent, and optionally a catalyst. The polycarboxy polymer in the pre-binder composition may be an organic polymer or oligomer that contains more than one pendant carboxy group prepared from unsaturated carboxylic acids, or it may be a homopolymer or copolymer prepared from unsaturated anhydrides. In addition, the polycarboxy polymer may be a copolymer of one or more unsaturated carboxylic acids or unsaturated anhydrides and a vinyl compound. The crosslinking agent may be a polyol that contains at least two hydroxyl groups (e.g., triethanolamine or glycerol). The catalyst may be an alkali metal salt of a phosphorous-containing organic acid (e.g., sodium hypophosphite or sodium phosphate) or a fluoroborate compound (e.g., fluoroboric acid or sodium tetrafluoroborate).

In addition, the dextrin binder composition contains a dextrin, a modified dextrin, maltodextrin, or a mixture thereof as a co-binder. The dextrin co-binder may be added to the pre-binder composition in an amount of up to 100% of the total binder composition. Preferably, the dextrin co-binder is added to the pre-binder composition in an amount of from 10-75% of the total binder composition such that the binder composition has a ratio of from approximately 90:10 to 25:75 (pre-binder:dextrin co-binder).

It is another object of the invention to provide a method of preparing a dextrin co-binder composition for glass fibers. To form a dextrin co-binder composition according to the instant invention, a pre-binder composition that includes a polycarboxy polymer and a crosslinking agent is formed. Optionally, the pre-binder composition includes a catalyst. The polycarboxy polymer, the crosslinking agent, and the optional catalyst may be admixed in any conventional mixing device for a period of time sufficient to homogenize the mixture. The catalyst may be pre-dissolved into solution prior to admixing. The polycarboxy polymer, the crosslinking agent, and the catalyst may be added to the mixing device in any order. Water may then be added to dilute the aqueous pre-binder composition to a viscosity and flow rate that is suitable for its application to glass fibers, such as by spraying or by impregnation into a mat.

Once the pre-binder composition is formed, a dextrin co-binder is added with agitation to form the final co-binder composition. The dextrin co-binder may be a yellow dextrin, a white dextrin, a British gum, a modified dextrin, a maltodextrin, or combinations thereof. The dextrin co-binder may be added in a powdered form or it may be dissolved in water prior to addition to the pre-binder composition. In addition, the dextrin co-binder may be added to the pre-binder composition in an amount of from 10-75% of the total binder composition such that the binder composition has a ratio of from approximately 90:10 to 25:75 (pre-binder: dextrin co-binder).

It is a further object of the present invention to provide a glass mat that includes a dextrin co-binder composition. A binder composition that contains dextrin, a modified dextrin, a maltodextrin, or combinations thereof as a co-binder such as is described above may be applied to a preformed fiberglass mat or veil in a wet-laid process. The pre-formed mat may be immersed into the dextrin co-binder composition to impregnate the binder into the mat. The mat may then be dried to remove any remaining water and to cure the binder. The resulting non-woven mat is an assembly of dispersed glass filaments that may be used to form fiberglass products or as reinforcements in flooring or roofing.

It is an advantage of the dextrin co-binder compositions according to the present invention that veils impregnated with the dextrin co-binder compositions have hot tensile strengths that are equal to or greater than the hot tensile strengths of veils impregnated with polycarboxylic acid based binder compositions that do not contain dextrin.

It is a further advantage of the present invention that veils impregnated with the dextrin binders of the present invention may be used in applications where the bonded mat has to maintain its strength in a hot environment, such as in calendar veil flooring applications or as an interlayer in vinyl flooring.

It is yet another advantage of the present invention that fibrous products formed with the dextrin co-binder compositions provide high hot tensile strengths using a reduced amount of polycarboxylic acid based binders, thereby reducing cost.

The foregoing and other objects, features, and advantages of the invention will appear more fully hereinafter from a consideration of the detailed description that follows, in conjunction with the accompanying sheets of drawings. It is to be expressly understood, however, that the drawings are for illustrative purposes and are not to be construed as defining the limits of the invention.

### BRIEF DESCRIPTION OF THE DRAWINGS

FIG. 1 is a graphical illustration of the tensile strengths and hot tensile strengths of a PVA pre-bonded veil treated with a polycarboxylic acid based binder and PVA pre-bonded veils treated with dextrin binder compositions according to the present invention;

FIG. 2 is a graphical illustration of the hot tensile strengths of a PVA pre-bonded veil treated with a polycarboxylic acid based binder and PVA pre-bonded veils treated with dextrin binder compositions according to the present invention having various dextrin sources; and

FIG. 3 is a graphical illustration of the hot tensile strength versus the curing time of a PVA pre-bonded veil treated with a polycarboxylic acid based binder and a PVA pre-bonded veil treated with a dextrin binder composition according to the present invention.

### DETAILED DESCRIPTION AND PREFERRED EMBODIMENTS OF THE INVENTION

Unless defined otherwise, all technical and scientific terms used herein have the same meaning as commonly understood by one of ordinary skill in the art to which the invention belongs. Although any methods and materials similar or equivalent to those described herein can be used in the practice or testing of the present invention, the preferred methods and materials are described herein. All references cited herein, including journal articles or abstracts, published or corresponding U.S. or foreign patent applications, issued U.S. or foreign patents, or any other references, are each incorporated by reference in their entireties, including all data, tables, figures, and text presented in the cited references.

The present invention relates to a polycarboxy binder composition that contains a dextrin or a modified dextrin as a co-binder. To form a dextrin binder composition according to the instant invention, a pre-binder composition that includes a polycarboxy polymer, a crosslinking agent, and optionally a catalyst is first formed.

A suitable polycarboxy polymer for use in the pre-binder composition is an organic polymer or oligomer that contains more than one pendant carboxy group. The polycarboxy polymer may be a homopolymer or copolymer prepared from unsaturated carboxylic acids including, but not limited to, acrylic acid, methacrylic acid, crotonic acid, isocrotonic acid, maleic acid, cinnamic acid, 2-methylmaleic acid, itaconic acid, 2-methylitaconic acid, α, β-methyleneglutaric acid, fumaric acid, monoalkyl maleates, monoalkyl fumarates, their corresponding alkali metal and ammonium salts, and combinations thereof. Alternatively, the polycarboxy polymer may be prepared from unsaturated anhydrides such as maleic anhydride, itaconic anhydride, acrylic anhydride, methacrylic anhydride, and mixtures thereof. Methods for polymerizing these acids and anhydrides are easily identified by one of ordinary skill in the art. The polycarboxy polymer may be present at a concentration of from about 1-50% by weight based on the total weight of the mixture.

In addition, the polycarboxy polymer may include a copolymer of one or more of the unsaturated carboxylic acids or anhydrides described above and one or more vinyl compounds including, but not limited to, styrene, α-methylstyrene, acrylonitrile, methacrylonitrile, methyl acrylate, ethyl acrylate, n-butyl acrylate, isobutyl acrylate, methyl methacrylate, n-butyl methacrylate, isobutyl methacrylate, glycidyl methacrylate, methyl vinyl ether, ethyl vinyl ether, propyl vinyl ether, isobutyl vinyl ether, 2-ethylhexyl vinyl ether, vinyl cyclohexyl ether, and vinyl acetate. Other suitable copolymers include, but are not necessarily limited to, α-olefins, (e.g. ethene, propene, butene, isobutene, pentene, cyclopentene, hexene, and cyclohexene), C₈-C₁₂-olefins (e.g., 1-dodecene), C₁₄-C₁₈-olefins (e.g., octadecene), C₂₀-C₂₄-olefins (e.g., 1-eicosene), acrylamides and substituted acrylamides (e.g., acrylamide, methacrylamide, and N-tert-butylacrylamide), sulfo-containing monomers (e.g., allylsulfonic acid, methallylsulfonic acid, and 2-acrylamido-2-methylpropanesulfonic acid), and butadiene. Methods for preparing these copolymers would be easily identified by those ordinarily skilled in the art.

The pre-binder composition according to the instant invention also includes a crosslinking agent. Crosslinking agents suitable for use in the binder composition include, but are not limited to, polyols that contain at least two hydroxyl groups, such as, for example, glycerol, trimethylolpropane, trimethylolethane, diethanolamine, triethanolamine, 1,2,4-butanetriol, ethylene glycol, glycerol, pentaerythritol, sorbitol, sucrose, glucose, resorcinol, catechol, pyrogallol, 1,3-propanediol, 1,4-butanediol, 1,6-hexanediol, 1,4-cyclohexane diol, 2-butene-1, erythritol, pentaerythritol, sorbitol, β-hydroxyalkylamides, trimethylol propane, glycolated ureas, and mixtures thereof. Preferably, the crosslinking agent is triethanolamine or glycerol.

The ratio of polycarboxy polymer to crosslinking agent may be determined by comparing the ratio of moles of hydroxyl groups contained in the polyol crosslinking agent to moles of carboxy groups contained in the polycarboxylic acid polymer. This stoichiometric ratio may vary over wide limits. The molar ratio of carboxylic acid groups from the polycarboxylic acid to the hydroxyl groups of the crosslinking agent may be from 1:3 to 5:1, preferably from 1:1 to 3:1. An excess of equivalents of carboxylic acid groups to the equivalents of hydroxyl groups is preferred.

Optionally, the pre-binder composition includes a catalyst. The catalyst may be present in an amount of from 0-20% of the pre-binder composition, preferably in amount of from 1-20%. The catalyst may include an alkali metal salt of a phosphorous-containing organic acid; in particular, alkali metal salts of phosphorus acid, hypophosphorus acid, or polyphosphoric acids. Examples of such phosphorus catalysts include, but are not limited to, sodium phosphite, potassium phosphite, disodium pyrophosphate, tetrasodium pyrophosphate, sodium tripolyphosphate, sodium hexametaphosphate, potassium phosphate, potassium polymetaphosphate, potassium polyphosphate, potassium tripolyphosphate, sodium trimetaphosphate, sodium tetrametaphosphate, and mixtures thereof. In addition, the catalyst may be a fluoroborate compound such as fluoroboric acid, sodium tetrafluoroborate, potassium tetrafluoroborate, calcium tetrafluoroborate, magnesium tetrafluoroborate, zinc tetrafluoroborate, ammonium tetrafluoroborate, and mixtures thereof. Further, the catalyst may be a mixture of phosphorus and fluoroborate compounds. Preferred catalysts include sodium hypophosphite, sodium phosphite, and mixtures thereof.

The pre-binder composition may optionally contain conventional additives such as dyes, oils, fillers, thermal stabilizers, emulsifiers, biocides, anti-foaming agents, anti-oxidants, organosilanes, colorants, and/or other conventional adjuvants. Other additives may be added to the pre-binder composition for the improvement of process and product performance. Such additives include coupling agents (e.g., silane, aminosilane, and the like), dust suppression agents, lubricants, wetting agents, surfactants, antistatic agents, water repellent agents, biocides, fillers, pigments, and/or flame retarding agents.

In a preferred embodiment, the pre-binder composition is Acrodur 950 L (formerly Acronal DS 2348), an aqueous thermosetting binder composition containing a modified polycarboxylic acid and a polyfunctional alcohol as a crosslinking agent, commercially available from BASF Corp.

The pre-binder composition may be formed by admixing the polycarboxy polymer, the crosslinking agent, and the catalyst (if present) in a conventional mixing device. Optionally, the catalyst may be pre-dissolved before admixing. Water may be added in an amount sufficient to dilute the aqueous pre-binder composition to a viscosity and flow rate that is suitable for its application to glass fibers, such as by spraying or by impregnation into a veil or mat. The terms “veil” and “mat” may be used interchangeably and are meant to include both woven and non-woven fabrics. Preferably, the pre-binder composition contains approximately 55-99% by weight water.

Once the pre-binder composition is formed, a dextrin may be added with agitation to form the dextrin binder composition. The dextrin may be added in a powdered form or it may be dissolved in water prior to its addition to the pre-binder composition to ensure a homogeneous mixture. Dextrins are partially hydrolyzed starches having the general chemical formula (C₆H₁₀O₅)ₙ.H₂O which may be prepared by heating or dry rotating starch, generally in the presence of an acid catalyst. Methods to convert starch to dextrins are well-known and would be easily conducted by one of ordinary skill in the art. For example, starch may be decomposed by the action of heat, with or without the addition of chemicals (e.g., acid catalysts), whereby the amylose and amylopectin molecules of the starch are broken down. Alternatively, the starch may be enzymatically decomposed to convert the starch to dextrins. The kind and duration of such treatment will determine the average molecular weight and molecular weight distribution of the dextrins. The conversion of the starch molecules to dextrin may be controlled to form yellow and white dextrins that exhibit good bonding and film forming properties. Compared to the parent starch molecules, dextrins have a higher solubility in cold water and develop a lower viscosity than concentrated binder compositions, which permits the dextrin-based binder composition of the instant invention to be more easily applied to fibrous materials, e.g., glass fibers, than conventional binder compositions.

Dextrins suitable for use in the binder composition may be obtained from a variety of starches and starch derivatives. Starches suitable for preparing the dextrins include, but are not limited to, corn, waxy corn, milo, white milo, wheat, potato, and tapioca. Examples of suitable dextrins for use in the binder composition include yellow dextrin (canary dextrin), white dextrins, and British gums. The dextrin may be a modified dextrin, e.g., a chemically modified dextrin, such as Inadpul DE-25, a 5-10% sodium metaborate modified dextrin (International Adhesives Bel.). Borax or borax and alkali (e.g., sodium tetraborate) may be added to chemically modify the dextrin. The amount of borax or sodium tetraborate added to modify dextrin may range up to approximately 20% of the dextrin weight. Alternatively, the dextrin may be a maltodextrin.

The dextrin, modified dextrin, maltodextrin, or a mixture thereof may be added to the pre-binder composition in an amount up to 100% of the total binder composition, preferably in an amount of from 10-75% of the total binder composition. The dextrin binder composition may have a ratio of from approximately 90:10 to 25:75 pre-binder composition:dextrin. In a preferred embodiment, the dextrin and pre-binder composition are present in the binder composition in an approximate 50:50 ratio.

Fibers that may be treated by the dextrin binder composition include glass fibers, carbon fibers, natural fibers (e.g., cotton), synthetic fibers (e.g., polyester, polyamide, and aramid), and mixtures thereof. Any type of glass fibers, such as A-type glass fibers, C-type glass fibers, E-type glass fibers, S-type glass fibers, or modifications thereof may be treated with the binder composition. For example, in one modification of E-type glass, the boron oxide is replaced by magnesium oxide. Such a glass is commercially available from Owens Corning Fiberglass Corporation under the trade name Advantex. Preferably, the fibers are E-type glass fibers or Advantex® glass fibers. The glass fibers may be formed by conventional techniques, such as by drawing molten glass into filaments through a bushing or orifice plate within a forming chamber. Glass fibers typically have a diameter of from about 3-24 microns and have a length of from about ¼ of an inch to about 3 inches.

The dextrin binder composition may be advantageously applied to a pre-formed fiberglass mat in a wet-laid process. In a wet-laid process, chopped fibers, e.g., chopped glass fibers, are dispersed in an aqueous solution which may contain a first binder as well as dispersants, viscosity modifiers, defoaming agents, and/or other chemical agents. In a preferred embodiment, the first binder contains a polyvinyl alcohol powder binder. The chopped glass fibers are then introduced into the aqueous solution and agitated such that the fibers become dispersed and form a slurry. The fibers located in the slurry may then be deposited onto a moving screen whereby water is removed to form a mat. Optionally, the mat may be dried in an oven. The mat may then be immersed into the dextrin binder composition whereby the binder impregnates the mat. The mat may then be dried to remove any remaining water and to cure the binder. The resulting non-woven mat is an assembly of dispersed glass filaments that may be used in reinforcements in flooring or roofing.

The dextrin binder composition of the present invention may also be used in the formation of fibrous insulation products. The manufacture of glass fiber thermal insulation may be carried out by a continuous process whereby molten glass flows from a melting furnace, divides into streams, and attenuates into fibers. The fibers are then collected on a conveyor belt to form a mat. The dextrin binder may be sprayed onto the fibers as they are dropping onto the collecting conveyor belt. The residual heat from the glass fibers and the flow of air through the fibrous mat during the forming operation are generally sufficient to volatilize a majority of the water from the binder, thereby leaving the remaining components of the binder on the fibers as a viscous or semi-viscous liquid. The binder-coated layer of fibers is then heated, such as by passing the mat through an oven, to evaporate any remaining water in the binder, cure the binder, and rigidly bond the fibers together where the fibers contact each other. The cured binder imparts strength and resiliency to the structure.

Mats or veils impregnated with dextrin binder compositions according to the instant invention may be used in the same applications as mats or veils impregnated with polycarboxylic acid based binder compositions. Therefore, the dextrin binder compositions may be used in the glass fiber industry to produce a wide range of glass fiber products, including, but not limited to, flooring, roofing products, insulation products such as fiberglass boards and fiberglass mats, reinforcement materials, and reinforced products.

One advantage of the dextrin binder compositions according to the present invention is that veils impregnated with the dextrin binder compositions have hot tensile strengths that are equal to or greater than the hot tensile strengths of veils impregnated with polycarboxylic acid based binder compositions that do not contain dextrin. Because of the high hot tensile strengths of veils impregnated with the dextrin binder compositions, the dextrin binder compositions may be used in applications where the bonded mat has to maintain its strength in a hot environment, such as in calendar veil flooring applications or as an interlayer in vinyl flooring. In addition, the dextrin binder compositions provide sufficient strength for glass mats used in flooring so that the glass mats do not separate or fall apart during the manufacturing steps of either the glass mat or the floor covering.

Additionally, the dextrin binder compositions provide high hot tensile strengths using a reduced amount of polycarboxylic acid based binders, which are typically expensive. As a result, less cost is incurred when applying the dextrin binder compositions to glass fibers, such as, for example, when impregnating a mat or veil with a dextrin binder composition according to the instant invention, than impregnating a veil with 100% of a polycarboxylic acid based binder composition. Thus, the dextrin binder compositions are cost-effective binders for the manufacture of glass fiber products.

Another advantage of the dextrin binder compositions is that they impart a low viscosity. The low viscosity of the dextrin binder compositions allows the binder to be applied via any conventional process, such as through kiss type rollers or by spraying the binder composition. In addition, the low viscosity of the dextrin binder composition permits the binder composition to be easily applied to porous substrates or fragile substrates which may break upon the application of a viscous binder composition. Further, the low viscosity of the dextrin binder composition permits the use of a high concentration of solids in the composition.

Having generally described this invention, a further understanding can be obtained by reference to certain specific examples illustrated below which are provided for purposes of illustration only and are not intended to be all inclusive or limiting unless otherwise specified.

### EXAMPLES

### Example 1

### Tensile Strength and Hot Tensile Strength of Dextrin Binder Compositions versus Polycarboxylic Acid Based Binder Composition

13% PVA pre-bonded veils (11 micron, 6 mm glass fibers) were treated with binder compositions differing in pre-binder:dextrin ratio. The binder compositions included 100% Acrodur 950L, 75% Acrodur 950L/25% dextrin, 50% Acrodur 950L/50% dextrin, 25% Acrodur 950L/75% dextrin, and 100% dextrin. Acrodur 950L is a polycarboxylic acid based binder composition that contains a modified polycarboxylic acid with a polyfunctional alcohol as a crosslinking agent (available from BASF). The dextrin used this example was a lab grade yellow dextrin obtained from Aldrich (Dextrin 26.075-4).

To form the various dextrin based binder compositions, the desired amount dextrin (e.g., 75%, 50%, 25%) was added to Acrodur 950L in a 10-50% pre-diluted solution. Any dextrin particles that did not dissolve were easily filtered out before the binder was applied to the pre-bonded veils. The mixtures were then agitated to homogenize the Acrodur 950L/dextrin solutions and form the dextrin based binder compositions. Each of the binder compositions were added to the veil via impregnation in a lab method simulating a conventional wet-laid process. In particular, the veils were impregnated in Foulard machine-type lab equipment and dried in a Mathis oven for three minutes at 200° C. to remove any remaining water and to cure the binder. The total binder Loss on Ignition (LOI) was approximately 35%. LOI may be defined as the percentage of organic solid matter deposited on the glass fiber surfaces.

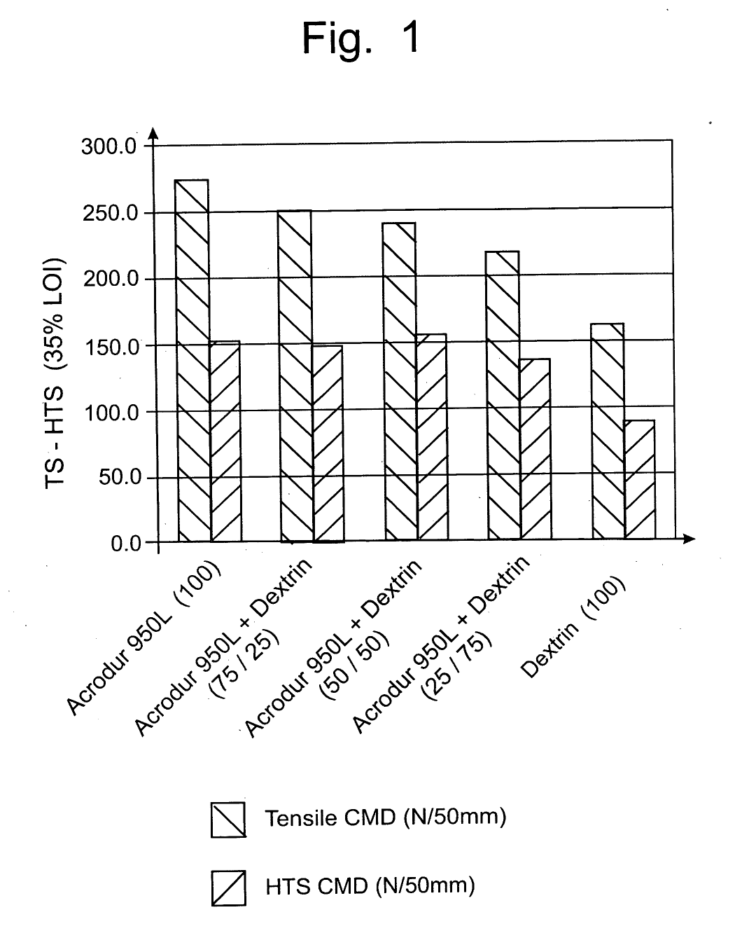

The tensile strength (TS) and hot tensile strength (HTS) of the binder-treated veils were determined in a cross-machine direction (CMD). The tensile strengths of the veils were measured on 50 mm×300 mm strips of the veil according to the procedure set forth in ISO 1924. To determine the hot tensile strengths of the veils, veil samples were placed in a 200° C. hot air flow (200 L/min). Approximately 30 cm² of the central surface of the veil sample was exposed to the air flux. The tensile strength was directly measured by a tensile tester. The results are depicted in FIG. 1. It can be seen that the dextrin based binder compositions up to and including a ratio of 50% Acrodur 950L and 50% dextrin yielded hot tensile strengths that were equal to or better than the veil treated with 100% Acrodur 950L. In addition, a satisfactory hot tensile strength was achieved even when the amount of polycarboxylic acid was reduced to a level of 25% of its original content by adding dextrin as a co-binder.

### Example 2

### Hot Tensile Strengths of Various Types of Dextrin Binder Compositions

Binder compositions formed of 50% Acrodur 950L/50% dextrin were prepared and used to impregnate a 13% PVA pre-bonded veil (11 micron, 6 mm glass fibers). The total binder LOI was approximately 35%. The dextrins used were obtained from unmodified potatoes, borax modified potatoes, and tapioca. The specific dextrins used to make the binder compositions are set forth in Table 1. With the exception of Crystal Tex 626, the tested dextrins were easily dissolved in water and had clear solutions.

TABLE 1

| | | | | | Viscosity of 10% |
|---|---|---|---|---|---|
| | | | | | Solution (1/1) |
| | | Starch | Solubility | | Acrodur |
| Name | Supplier | Type | in Water | Color | 950L/Dextrin |
| Dextrin | Aldrich | Potatoes | 99.5% | yellow | 3.3 cps |
| 26.075-4 | | | | | |
| Crystal Tex | National | Tapioca | high | off-white | 3.1 cps |
| 626 | Starch | | | | |
| K4484 | National | Tapioca | high | pale yellow | |
| | Starch | | | | |
| Inadpul DE-25 | International | Potatoes | 100% | pale brown | 3.3 cps |
| | Adhesives | (borax | (pH: 9.5) | | |
| | Bel. | modified) | | | |
| Inadpul DE-12 | International | Potatoes | 100% | pale yellow | 2.8 cps |
| | Adhesives | | (pH: 2.5) | | |
| | Bel. | | | | |

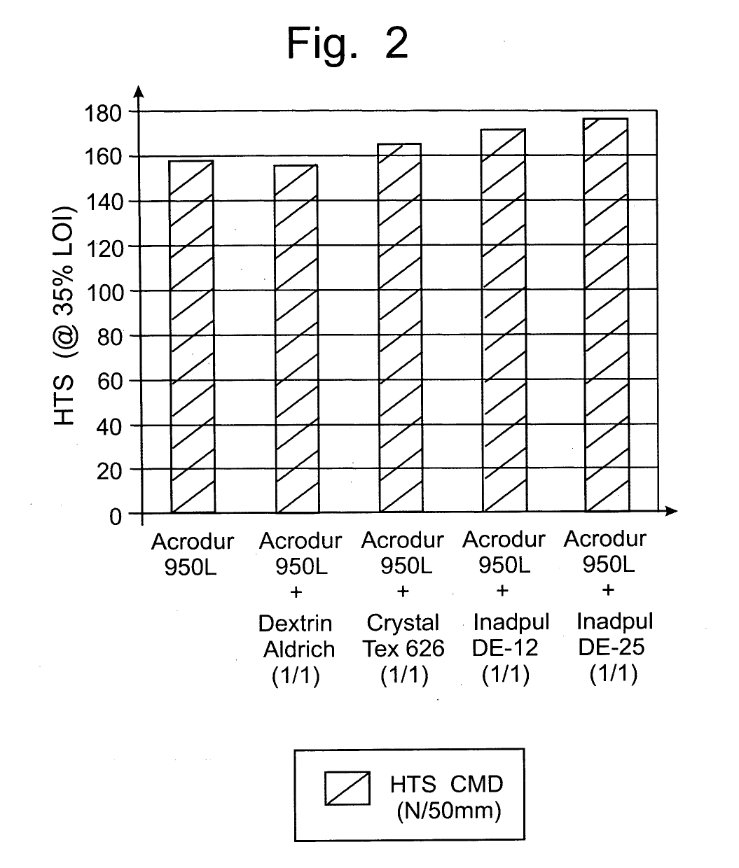

The hot tensile strengths of the veils containing the dextrin binder compositions were determined and compared to the hot tensile strength of a PVA pre-bonded veil impregnated with 100% Acrodur 950L. The results are illustrated in FIG. 2. It was determined that veils impregnated with the dextrin binder compositions, no matter what the source of the dextrin, had a hot tensile strength equal to or better than the veil impregnated with 100% Acrodur 950L. It was surprisingly determined that the binder compositions formed with Crystal Tex 626, Inadpul DE-12, and Indapul-25 dextrins had increased hot tensile strengths up to approximately 175 N/50 mm. Thus, it appears that these dextrin/polycarboxylic acid binder combinations had unexpected synergistic effects.

### Example 3

### Hot Tensile Strength versus Curing Time of a Dextrin Binder Composition

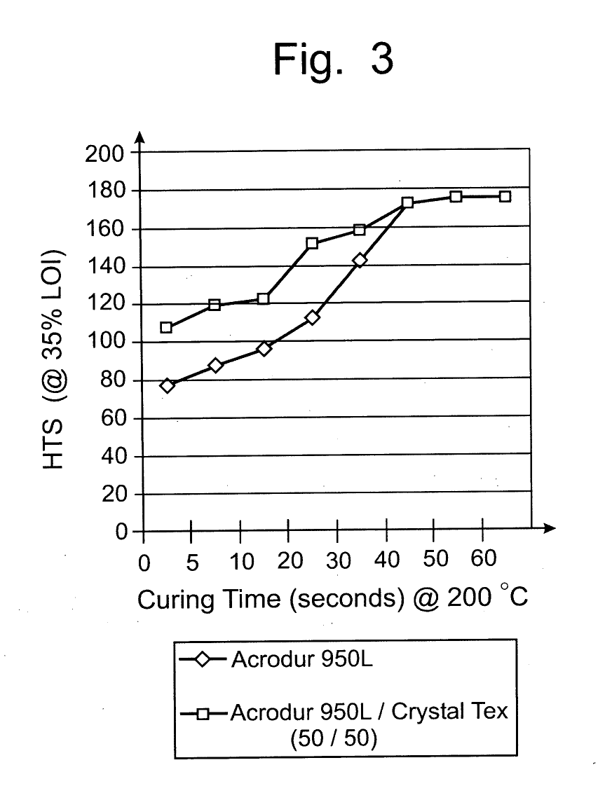

A 13% PVA pre-bonded veil (11 micron, 6 mm glass fibers) was impregnated with 100% Acrodur 950L and, in a separate experiment, the same veil was impregnated with a dextrin-based binder composed of 50% Acrodur 950L and 50% Crystal Tex 626 from National Starch. Both veils had a total binder LOI of approximately 35%. The veils were dried at 100° C. for 5 minutes and then placed in a Mathis oven at 200° C. for different periods of time. The hot tensile strength of each of the veils was measured at 5, 10, 20, 30, 40 50 and 60 seconds. The results of the hot tensile strength of each of the binder coated veils versus the curing time is shown in FIG. 3. FIG. 3 clearly illustrates that although the thermal treatment for the veils was the same, the dextrin binder coated veil had a hot tensile strength value that was approximately 40% higher than the hot tensile strength of the Acrodur 950L coated veil at time zero. This initially higher hot tensile strength demonstrates that the veil coated with the dextrin binder composition had a higher strength early in the curing process, when conventional veils are usually fragile. Because the dextrin binder coated veil had a higher hot tensile strength, such a veil would be able to withstand higher speed on the production line, have a lower sensitivity to deformation, and less surface defects.

The invention of this application has been described above both generically and with regard to specific embodiments. Although the invention has been set forth in what is believed to be the preferred embodiments, a wide variety of alternatives known to those of skill in the art can be selected within the generic disclosure. The invention is not otherwise limited, except for the recitation of the claims set forth below.

1. A binder composition for glass fibers comprising:
a pre-binder composition including a polycarboxy polymer and a crosslinking agent; and
a co-binder selected from the group consisting of a dextrin, a modified dextrin, maltodextrin and mixtures thereof.

2. The binder composition according to claim 1, wherein said pre-binder composition further includes a catalyst.

3. The binder composition according to claim 2, wherein said catalyst is selected from the group consisting of an alkali salt of a phosphorus containing organic acid, a fluoroborate compound and mixtures thereof.

4. The binder composition of claim 1, wherein said crosslinking agent is a polyol containing two or more hydroxyl groups.

5. The binder composition of claim 4, wherein said crosslinking agent is selected from the group consisting of triethanolamine and glycerol.

6. The binder composition of claim 1, wherein said binder composition has a pre-binder composition:co-binder ratio of from 90:10 to 25:75.

7. The binder composition of claim 1, wherein said modified dextrin is selected from the group consisting of borax modified dextrins and borax-alkali modified dextrins.

8. A glass fiber mat comprising:
a plurality of randomly oriented glass fibers; and
a binder composition applied to at least a portion of said glass fibers, said binder composition including:
a pre-binder composition, said pre-binder composition having a polycarboxy polymer and a crosslinking agent; and
a co-binder selected from the group consisting of a dextrin, a modified dextrin, maltodextrin and mixtures thereof.

9. The glass fiber mat according to claim 8, wherein said binder composition further comprises a first binder.

10. The glass fiber mat according to claim 9, wherein said first binder is a polyvinyl alcohol.

11. The glass fiber mat according to claim 8, wherein said pre-binder composition further comprises a catalyst.

12. The glass fiber mat according to claim 8, wherein said binder composition has a pre-binder composition:co-binder ratio of from 90:10 to 25:75.

13. The glass fiber mat according to claim 8, wherein said modified dextrin is selected from the group consisting of borax modified dextrins and borax-alkali modified dextrins.

14. The glass fiber mat according to claim 8, wherein said glass mat is incorporated into a fiberglass product.

15. A method of preparing a dextrin co-binder composition for glass fibers comprising:
forming a pre-binder composition, said pre-binder composition including a polycarboxy polymer and a crosslinking agent; and
adding a co-binder selected from the group consisting of a dextrin, a modified dextrin, maltodextrin and mixtures thereof to said pre-binder composition to form said dextrin co-binder composition.

16. The method of claim 15, wherein said forming step comprises the steps of:
admixing said polycarboxylic polymer and said crosslinking agent to form a mixture; and
adding water to said mixture in an amount sufficient to dilute said mixture to a viscosity suitable for application to glass fibers.

17. The method of claim 16, wherein said pre-binder composition further includes a catalyst, said catalyst being admixed with said polycarboxy polymer and said crosslinking agent to form said mixture.

18. The method of claim 17, further comprising the step of:
pre-dissolving said catalyst prior to said admixing step.

19. The method of claim 15, wherein said co-binder is added to said pre-binder composition in an amount of from 10% to 75% of said co-binder composition.

20. The method of claim 15, further comprising the step of:
pre-dissolving said co-binder prior to said adding step.
